(19) United States
(12) Patent Application Publication
(10) Pub. No.: US 2023/0101582 A1
(43) Pub. Date: Mar. 30, 2023

(54) Step-Up Trusted Security Authentication Based on Wireless Detection and Identification of Local Device(s) with Unique Hardware Addresses

(71) Applicant: Bank of America Corporation, Charlotte, NC (US)

(72) Inventors: Bradley Long, Matthews, NC (US); Joshua S. Burrell, Carlotte, NC (US); Rosemary Hill, Jacksonville, FL (US)

(21) Appl. No.: 17/487,834

(22) Filed: Sep. 28, 2021

(51) Int. Cl. G06Q 20/32; G06Q 20/20; G06Q 20/40; H04L 29/06

(52) U.S. Cl. CPC G06Q 20/3227; G06Q 20/202; G06Q 20/4014; G06Q 20/4015; H04L 63/0876

(57) ABSTRACT

Information security processes, systems, and machines for authenticating users, wirelessly detecting a user's local devices, calculating a trust score based on the local devices, and setting a transaction limit are disclosed. An ATM or POS machine can read a card, authenticate a user, and wirelessly read MAC or other unique hardware addresses for one or more of the user's local devices. Trust scores can be calculated based on the number of local devices that are detected in relation to the number of the user's devices that are registered, the historical presence of the user's devices during prior transactions, historical usage of the ATM or POS machine, geolocating, biometric authentication(s), etc. Dynamic transaction limits, types, and rights may be set for transactions corresponding to the trust score values. Transactions may be conducted wholly or partially in a contactless fashion.

### TECHNICAL FIELD OF DISCLOSURE

The present disclosure relates to processes and machines for information security access control and authentication including, in particular, systems, processes, and apparatus for the prevention of unauthorized access to resources of a system or information system, including the manner of identifying and verifying the entity, process, or mechanism requesting access to the resource based on wireless detection, identification, and validation of detected unique hardware addresses corresponding to local wireless devices that are detected to be in proximity to the resource and are previously preregistered and therefore known to be valid.

### BACKGROUND

Traditional authentication of a user at an automated teller machine (ATM) or point-of-sale (POS) machine is typically performed by insertion of a physical card into an ATM or POS card reader or by wireless reading of the card by the ATM or POS. Users may provide additional security information such as a user PIN for the user's account or a zip code associated with the billing address for the user's account.

Banks typically have a set transaction limit for ATM transactions or POS purchases, such as at pumps at gas stations. These limits, for security purposes, may be relatively low. For example, a user may only be able to withdraw $300 from an ATM per day. Or the user might only be able to purchase $75 of gasoline from a gas pump at a gas station. This can be frustrating for users who need to withdraw larger amounts of currency or need to spend more on gasoline based on high gas prices, which increase over time.

Additional security concerns may be raised by use of cards in different geographical locations as users travel. For example, if users who live in one country travel to another country and attempt to use their cards, the transactions may be erroneously declined because a company may suspect that the transaction is potentially fraudulent since the user may not have been in that geographical location before or was not expected by the company to be in that region at the time the transaction was initiated. This situation would result transactions being inappropriately declined and/or in users having to contact the company to confirm their identity and the transaction, which is frustrating to users during their travels.

### SUMMARY

Aspects of this disclosure address one or more of the shortcomings in the industry by, inter alia, providing non-intrusive, automated, additional security verifications to authenticate users based on wireless portable electronic devices that may be in the user's local possession when the user is attempting to process a transaction at an ATM or make a purchase at a POS. The devices may be detected automatically and wirelessly via Bluetooth, Ultra-Wideband (UWB) networking, Wi-Fi, or other wireless protocol. Hardware addresses for the devices may be read and compared against a preregistered known list of the user's devices in order to create a trust score. Any type of unique hardware address may be used as described herein. As the number of authenticated devices that are detected and verified increases, a company's confidence or trust—that users are who they claim to be and that the transaction is non-fraudulent—increases. As trust increases, the company may be willing to authorize transactions of increasingly higher limit(s), allow different transaction types such as account or wire transfers etc. in addition to simple cash withdrawals or purchases, and/or allow different accounts to be accessed.

As used herein, Bluetooth refers to the global standard of well-known simple, secure device communication. This includes both Bluetooth Classic, which is point-to-point device communication based on classic radio technology. It also includes Bluetooth Low Energy, which can be point-to-point, broadcast, or mesh device communication, or device positioning based on proximity, direction, or distance.

As used herein, UWB refers to radio-based communication technology for short-range use to provide fast and stable transmission of data. UWB technology provides real-time location detection functionality, real-time proximity analyses, and precise calculation of embedded sensor locations for a response device within the UWB range of an initiating device using “time of flight” (ToF) of transmission at various frequencies as all discussed below. UWB is able to transmit information across a wide bandwidth of >500 MHz. This allows for the transmission of a large amount of signal energy without interfering with conventional narrowband and carrier wave transmission in the same frequency band. Wave-based systems—where each transmitted wave occupies the UWB bandwidth (or an aggregate of at least 500 MHz of narrow-band carrier; for example, orthogonal frequency-division multiplexing (OFDM))—can access the UWB spectrum under recently published HRP and LRP industry standards and current regulatory rules.

References to “wireless” communication, as used herein, encompass use of Bluetooth and UWB as well as other commercially available wireless technology such as Wi-Fi, IoT, and the like. All are considered to be within the spirit and scope of the invention as would be understood by skilled artisans and, for brevity, are therefore not discussed in detail herein.

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions of this application are disclosed in the specification throughout this application along with exemplary, non-exhaustive, and non-limiting manners and processes of making and using the inventions, in such full, clear, concise, and exact terms in order to enable skilled artisans to make and use the inventions without undue experimentation and sets forth the best mode contemplated by the inventors for carrying out the inventions.

In accordance with one or more arrangements of the disclosures contained herein, solution(s) provide an authentication process for a machine (such as an ATM or POS) to authenticate a user with a card (such as a debit card, credit card, bank card, gift card, etc.), which can be chipped and/or have a magnetic strip, based on wireless detection of a user's local wireless devices. The machine may read account information corresponding to the card either wirelessly or by physical insertion of the card into the machine. A user may input a PIN, zip code, or other security information into the machine that corresponds to the card. The machine may wirelessly detect various of the user's devices that are located in proximity to the machine and/or are in the user's possession. The machine may wirelessly retrieve the media access control (MAC) addresses for the user's devices or any other types of unique hardware addresses. The machine may transmit account information for the card, the security information, and the MAC addresses of the detected devices to an authentication server. The user's devices may be preregistered by the user with the authentication server via a mobile app, web interface, or the like. The authentication server may determine a trust score based on the number and/or type of devices that are present with the user at the machine. A transaction limit and/or transaction type rights may be set based on the trust score. As the trust score increases, the company may provide, inter alia, higher limits or increase usage rights. Conversely, as the trust score decreases, lower limits or decreased usage rights may be authorized. Transactions may be completely declined if the trust score does not exceed a minimum security threshold or if red flags are detected.

Any type of wirelessly enabled device with a unique hardware address could be utilized with the inventions of this disclosure. This includes, but is not limited to, smartphones, smart devices, smart watches, tablets, fitness trackers, Tile trackers, wireless headphones, smart glasses, AirTags, etc.

Trust scores may also take into consideration the geographical location of the proposed transaction as well as the user's historical performance of transactions in that geographical area or region.

In some configurations, all of the applicable information necessary to calculate trust scores may reside on the ATM or POS itself. In other configurations, some or all of the information may reside on one or more authentication or other servers. In the latter case, information would be transmitted by the ATM or POS to the server for trust score calculations and transaction limit/rule setting, and returned to the ATM or POS as appropriate in order to allow or decline the proposed transaction. Otherwise, such processing may be performed entirely on the ATM or POS.

In some configurations, additional or alternative authentication may be provided based on biometrics. This includes, but is not limited to, facial recognition, retinal scanning, fingerprint reading, voice recognition, or the like. The biometric authentication may be performed by the ATM or POS itself, or may be performed by an app or other component on one or more of the user's devices, such as a smartphone, which may be operated at the time of the transaction at the ATM or POS.

In some configurations, an automated teller or POS system for use with an authentication server to authenticate a user with a card based on wireless detection of one or more of the user's local wireless devices can be provided. The system can include: at least one ATM or POS having: at least one processor, at least one non-wireless communication interface communicatively coupled to the at least one processor and the authentication server, a wireless card reader communicatively coupled to the at least one processor and the card, a wireless communication interface, communicatively coupled to the at least one processor, in wireless communication—via Bluetooth, Ultra-Wideband, or other wireless protocol—with one or more of the local wireless devices, and a memory communicatively coupled to the at least one non-wireless communication interface. The memory may store computer-executable instructions that, when executed by the at least one processor, cause the machine to perform various functions. Account information may be wirelessly read from the card. One or more of the user's local wireless devices may be wirelessly detected and one or more media access control (MAC) addresses can be read from the one or more local wireless devices. The account information and MAC addresses may be transmitted to an authentication server or the like for authentication and for a determination of a trust score. Authentication verification and a transaction limit authorization may be determined by the server based on the trust score. Transactions may be processed if the amount of the transaction is less than or equal to the transaction limit, or declined if the amount exceeds the limit. Or, the foregoing functionality may be implemented entirely on an ATM or POS itself.

In some configurations, the trust score can be calculated based on how many of the one or more MAC addresses are authenticated. The trust score may increase as the number of MAC addresses are authenticated increases and the transaction limit authorization and/or usage rights may increase as the trust score increases. Conversely, the trust score may decrease as the quantity of the authenticated devices decrease and the transaction limit authorization and/or usage rights may thereby decrease as well. Trust scores can also be reduced if devices are detected that duplicative to devices in the preregistered known list and that have unverified addresses. This might trigger a security flag as an example.

In some configurations, the trust score may be additionally or alternatively based on the number and/or type of local devices typically present with the user during various types of transactions. For example, the users may always have smartphones with them and the absence of smartphones at the time of the transaction may raise a question regarding whether the transaction may be fraudulent and, accordingly, may decrease the trust score based on historical usage.

In some configurations, the entire ATM or POS transaction may be performed in a contactless fashion. In such an arrangement, the processing may be performed entirely locally at the ATM or POS, or may be performed in conjunction with an authentication server.

In some configurations, a contactless ATM system to authenticate a user with a card based on wireless detection of one or more of the user's local wireless devices can be provided. For example, an ATM can have an ATM processor, an ATM communication interface communicatively coupled to the ATM processor, and an ATM wireless interface, communicatively coupled to the ATM processor, in wireless communication, via a Bluetooth protocol or Ultra-Wideband (UWB) protocol, with one or more of the local wireless devices and with the card. An authentication server can have: an authentication processor; and an authentication communication interface communicatively coupled to the authentication processor and the ATM communication interface.

An ATM memory can be communicatively coupled to the ATM communication interface and an authentication memory can be communicatively coupled to the authentication communication interface. The ATM memory can store ATM computer-executable instructions that, when executed by the ATM processor, cause the ATM to perform ATM functions. The authentication memory can be communicatively coupled to the authentication communication interface. The authorization memory can store authentication computer-executable instructions that, when executed by the authentication processor cause the authentication server to perform server functions.

The ATM can wirelessly read, via the wireless interface, card information for the card and one or more media access control (MAC) addresses or other unique addresses for the one or more local wireless devices. The ATM can transmit, from the ATM communication interface to the authentication communication interface, the card information and the MAC addresses. The authentication processor can receive, from the authentication communication interface, the card information and the MAC addresses. The authentication processor can retrieve, from the authentication memory, account information corresponding to the card information and a known list of the user's local wireless devices. The authentication processor can calculate a trust score based on: the account information, and a ratio of the MAC addresses that were detected to the known list of the user's local wireless devices. The trust score can vary directly with the ratio. The authentication processor can set a transaction limit or usage rights based on the trust score and the account information. The authentication processor can transmit, from the authentication communication interface to the ATM communication interface, the transaction limit and/or usage rights. The ATM processor can receive, from the ATM communication interface, the transaction limit or usage rights. The ATM processor processes a transaction if an amount of the transaction is less than or equal to the transaction limit authorization or is within the usage rights. The ATM processor can reject the transaction if the amount of the ATM transaction is greater than the transaction limit authorization or is outside the allowed usage rights.

Similarly, a POS machine, as opposed to an ATM machine, may be implemented in the same or a similar fashion as noted above. Descriptions of ATMs as contained herein would be the same for POS machines and are therefore not repeated in the interest of brevity, but are still within the scope of the disclosure.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a functional block diagram of an operating environment for ATM (or POS) hardware and software, a user with Bluetooth, UWB or other wireless portable electronic devices that have unique hardware addresses, and authentication or other server hardware and software in which certain aspects of the present disclosure may be implemented.

FIG. 2 is a geographical representation of using utilizing Bluetooth, UWB, or other wireless technology in suitably enabled ATM (or POS) machine(s) to detect when wireless devices are present within a range of the user and machine at the time of the proposed transaction in which certain aspects of the present disclosure may be implemented.

FIG. 3 is a functional block diagram depicting an exemplary “time of flight” (ToF) method of utilizing UWB technology to locate wireless devices in relation to UWB-enabled ATM (or POS) machine(s) in which certain aspects of the present disclosure may be implemented.

FIG. 4 illustrates how a trust score can be correlated to various levels of transaction authorization levels or transaction type rights in which certain aspects of the present disclosure may be implemented.

FIG. 5 illustrates how one or more aspects of the disclosure can overcome erroneous fraudulent detections based on different geographical locations in which certain aspects of the present disclosure may be implemented.

FIG. 6 is an illustrative flowchart of sample method steps, which focus on ATM or POS processing, that can be performed in accordance with various aspects of the disclosure to provide improved authentication of a user with a card based on Bluetooth, UWB, or other wireless detection of a user's local wireless devices with unique hardware addresses in which certain aspects of the present disclosure may be implemented.

FIG. 7 is an illustrative flowchart of sample method steps, which focus on authentication server processing, that can be performed in accordance with various aspects of the disclosure to provide improved authentication of a user with a card based on Bluetooth, UWB, or other wireless detection of a user's local wireless devices with unique hardware addresses in which certain aspects of the present disclosure may be implemented.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized and structural and functional modifications may be made.

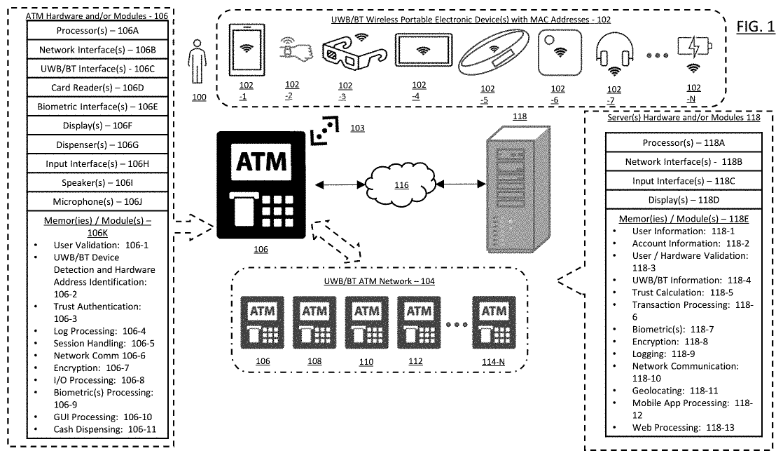

FIG. 1 illustrates a functional block diagram of an operating environment for ATM (or POS) hardware and software, a user with Bluetooth, UWB or other wireless portable electronic devices that have unique hardware addresses, and authentication or other server hardware and software. For brevity, the drawings only refer to UWB and/or Bluetooth, but any wireless communication technology may be used. Functionality shown as part of authentication server 118 can be implemented additionally and/or alternatively on ATM 106, POS, or the like.

Users 100 may have one or more Bluetooth, UWB, or otherwise wirelessly enabled portable electronic devices 102 with them when approaching an ATM (or POS) machine 106, such as in ATM network 104, which may comprise ATMs or POS machines 106, 108, 110, 112, 114, etc. Although reference is made in the drawings to ATMs, the present disclosure is not limited to ATMs and would apply equally to POS machines and have the same or similar components as the ATMs. For brevity, only ATM nomenclature is used in the drawings.

User wireless portable electronic devices 102 may include smartphones 102-1, smart watches 102-2, smart glasses 102-3, tablets 102-4, fitness trackers 102-5, Tile trackers or AirTags 102-6, headphones 102-7, or any other wirelessly accessible electronic device with a unique hardware address 102-N. Preferably, each wireless device 102 will have a media access control (MAC) address that uniquely identifies it. As such, a list of a user's electronic devices and a corresponding list of MAC addresses can be compiled. These devices and MAC addresses can be preregistered with a company, associated with the user's account(s), and stored in memory, databases, and/or the like. If desired, hardware addresses can include additionally or alternatively device make/model names with serial numbers, MAC address(es), Bluetooth address(es), IMEI numbers, ICCID numbers, SEID identifiers, and/or any other identifier that may be unique for the hardware device. For brevity, only MAC addresses are referenced herein, but any type of unique address may be used.

ATM 106 is in wireless communication 103 via Bluetooth, UWB, or the like with portable electronic devices 102 as the user approaches the ATM 106. The ATM 106 may have various hardware components such as processor(s) 106A, network interface(s) 106B, UWB/Bluetooth or other wireless interface(s) 106C, a card reader 106D to read magnetic cards or chipped cards such as debit and credit cards, etc., 106D biometric interface(s) 106E, display(s) 106F, cash dispenser(s) 106G, touchscreen or keypad input interface(s) 106H, speaker(s) 1061, and/or microphone(s) 106J.

ATM 106 may also have one or more memories 106K that can store processor-executable instructions/modules and can store or access data. These modules, routines, components, and/or functions may reside in non-volatile local memory in one or more sectors of memory, data stores, and/or data structures in the memory.

For example, a user validation module 106-1 may enable user identification and/or security confirmation by reading card information and processing securing information such as PINs, zip codes, or the like. A Bluetooth, UWB, or other wireless device detection and hardware address identification module 106-2 can detect when a user's wireless devices are within range of the ATM 106 (or POS) and can read unique hardware addresses, such as MAC addresses, from the devices. A trust authentication module 106-3 may decide locally about the level of trust to be associated with the transaction based on user information and/or the detected local devices, or may process the data and transmit it to an authentication server for trust processing.

A log processing module 106-4 may log the transaction and may keep a log of past transactions. Such log information may be used in the trust processing and/or may be provided to an authentication server for archival purposes or for trust processing of future transactions. A session handling module 106-5 may control the ATM session and handle inputs and outputs for the session. A network communication module 106-6 may facilitate transmission of information from an ATM or POS to an authentication server and may receive transmissions therefrom. An encryption module 106-7 may encrypt or decrypt data transfers and transmissions sent to and/or received by the ATM or POS, the user's card, and authentication servers. An I/O processing module may handle all inputs from the user or card to the ATM or POS or outputs to the user.

A biometrics processing module 106-9 may allow the ATM or POS to perform facial recognition, fingerprint scanning, retinal scanning, and/or voice recognition in order to further validate the user at the time of transaction. This processing may be performed entirely on the ATM or POS. Or the data input may be handled by module 106-9 and transferred to an authentication server for validation. Alternatively, the processing may be performed in conjunction with an app or other component on smart device 102, which would be in communication directly with the ATM or POS or indirectly through the cloud to a processing server or the ATM or POS.

A GUI processing module 106-10 can handle generation of graphical user interfaces and display instructions or inputs on the ATM or POS. It may also handle display of texts or graphical objects, selectable buttons or icons or the like. A cash dispensing module 106-11 may handle physical inputs or outputs of physical currency.

ATM or POS 106 may be in wired and/or wireless communication with one or more authentication servers 118 or data sources. Authentication hardware and/or processing implemented on server(s), with central processing hardware, and/or central processing components such as processor(s) 118A, network interface(s) 118B, input interface(s) 118C, and display(s) 118D. One or more centralized and/or distributed memories, storage device(s), and/or databases 118E in communication therewith may be used to store relevant modules, jobs, routines, data, and/or computer-executable instructions for implementing various server aspects of this disclosure. This includes user information 118-1, account information 118-2, user and hardware validation 118-3, Bluetooth, UWB, or the like storage of preregistered hardware devices associated with the user, trust calculation processing 118-5, transaction processing 118-6, biometrics information or processing correlated to the user and/or for interacting with third party mobile biometric devices 118-7, encryption processing 118-8 to encrypt and/or decrypt information exchanged with users or ATMs/POS machines etc., logging modules and data logs for storing historical information and updating accounts 118-9, network communication modules 118-10 to communicate with distributed processing or data stores or to communicate with ATMs and POS machines, geolocating information regarding present and past transaction locations or user travels 118-11, mobile app processing 118-12 for preregistration purposes or biometrics handling, and web processing 118-13 for preregistration purposes. One or more portions of the foregoing may be stored in one or more sectors of integrated and/or accessible non-volatile memory, memories, data stores, databases or the like.

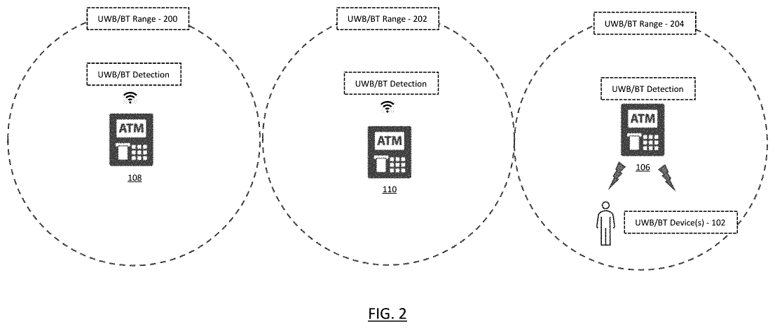

FIG. 2 is a geographical representation of using utilizing Bluetooth, UWB, or other wireless technology in suitably enabled ATM (or POS) machine(s) to detect when wireless devices are present within a range of the user and machine at the time of the proposed transaction in which certain aspects of the present disclosure may be implemented. For example, ATM/POS machines 108 and 110 may constantly monitor, detect, and/or poll wireless devices within their respective Bluetooth, UWB, or other wireless ranges 200 and 202. When a user approaches an ATM or POS machine 106 and/or their wireless device(s) 102 are detected by the machine as being within its range 204, the processing of various aspects of this disclosure can take place and the inventions may be implemented as explained herein.

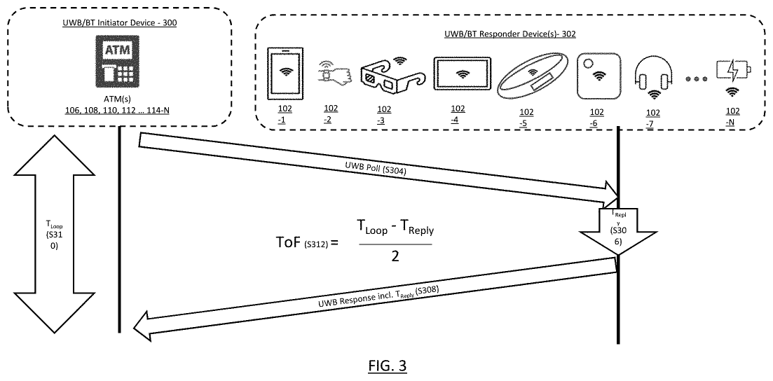

FIG. 3 is a functional block diagram depicting an exemplary “time of flight” (ToF) method of utilizing UWB technology to locate UWB-enabled devices in relation to UWB-enabled ATM machine(s) in which certain aspects of the present disclosure may be implemented. Similar functionality may be used for Bluetooth or other wireless device detections and communications.

As illustrated in FIG. 3, a UWB (or other) initiator device 300 (e.g., a UWB-enabled ATM/POS 106) can send a poll message in step 304 to a UWB responder device 302 such as any of the discussed wireless devices 102. The amount of time for the device 302 to reply to the poll message can be determined in step 306. A UWB or other wireless response can then be returned in step 308 to the initiator device 300 and the time for the loop can be determined in step 310 such that the time of flight (ToF) can be calculated in step 312 based on subtracting the reply time from the loop time, and then dividing the result by 2. This can be used to determine whether a UWB (or other) responder device 302 is within range of the UWB initiator device 300 and/or whether the UWB (or other) responder device 302 is within a pre-determined “desired” range of the UWB (or other) initiator device 300.

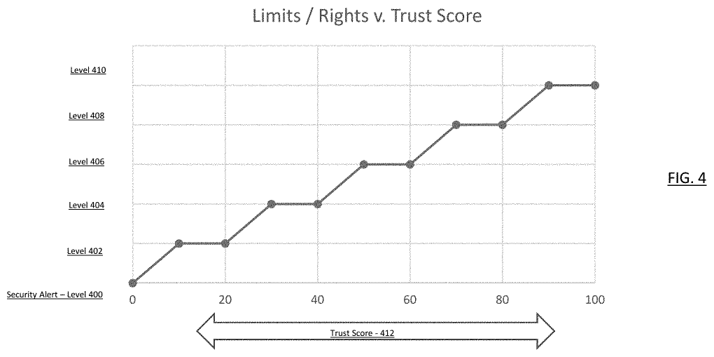

FIG. 4 graphically illustrates how a trust score can be correlated to various levels of transaction authorization levels or transaction type rights in which certain aspects of the present disclosure may be implemented.

On the horizontal axis, the trust score 412 for a user and/or requested transaction can vary across a range of, for example, from 0% reliability to 100% reliable. The range may be represented in percentages and/or as other various numeric values or the like. On the vertical axis, different levels of transaction limits or usage rights may be assigned to corresponding trust score levels.

For example, if the trust score is 0%, a security alert (i.e., level 400) may be triggered. This might be the case if none of the user's wireless devices are detected, the PIN, zip code, or other security code information is incorrect, one or more biometric challenges fail, or the like. Or it may be triggered if duplicative differing devices are detected that do not match the preregistered known devices. In such a case, no rights or limits may be authorized.

At level 402, perhaps a trust score of 10% is detected based on trust score criteria. This might be associated with a minimum transaction limit level or limited transaction type rights. As an example, this minimal level may only allow a transaction of $100 or less and may only allow the user to withdraw funds from a certain account or access only a certain account.

Rights and limits may be progressively increased at levels 404, 406, 408, and ultimately 410 as the trust score increases from 10-100%. Increased levels 404-410 may allow higher transaction amounts such as respectively $300, $500, $1000, or unlimited. And may also allow additional transaction types (e.g., wire transfers, account transfers, bill payments, deposits, cryptocurrency transactions, equity transactions, account modifications, etc.) and may allow access to different accounts other than just the base account.

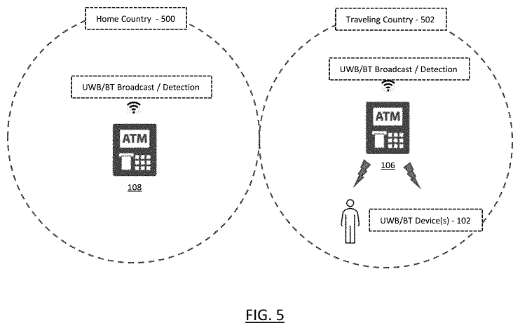

FIG. 5 illustrates how one or more aspects of the disclosure can overcome erroneous fraudulent detections based on different geographical locations in which certain aspects of the present disclosure may be implemented. For example, a company may typically expect a user's transactions to occur within the user's home country 500 (e.g., the United States) at one or more known or regional ATMs or POS machines 108. And the institution might normally flag transactions occurring in other countries 502 that might be visited by a user as potentially fraudulent if the company was not expecting travel. However, one or more aspects of this disclosure can overcome these false alerts if an ATM or POS 106 successful detects one or more wireless devices 102 as being in the possession of the user 100. Such a detection would decrease the odds that the card was stolen. This is due to the fact that just because a card might have been stolen, the user's other electronic devices might not have been stolen. So the detected presence of the devices increases the company's trust that the transaction is valid.

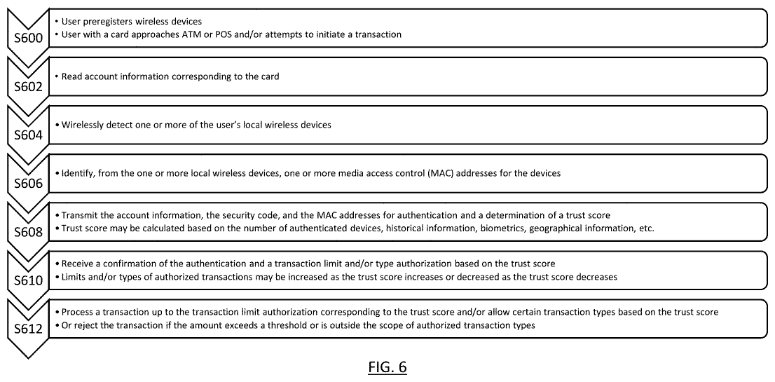

FIG. 6 is an illustrative flowchart of sample method steps, which focus on ATM or POS processing, that can be performed in accordance with various aspects of the disclosure to provide improved authentication of a user with a card based on Bluetooth, UWB, or other wireless detection of a user's local wireless devices with unique hardware addresses in which certain aspects of the present disclosure may be implemented. Some or all of these steps may be implemented at an ATM or POS, or may optionally be implemented on an authentication server.

In step 600, a user can preregister one or more of their wireless devices with unique hardware addresses. This information could be registered manually or automatically by accessing a company's app on a smart device or via an institution web site. The hardware address information can be associated with the user and/or the user's accounts, and can be stored for future reference and trust scoring/validating.

Also in step 600, a user may approach an ATM or POS and may attempt to initiate a transaction. Traditional identification and verification processes may be performed. Biometrics or other validation may also be performed.

In step 602, an ATM or POS may read account information corresponding to the card. This may take the form of reading information from a magnetic strip on the card or reading the chip on the card. It may also take place by wirelessly reading the information from the card via Bluetooth, UWB, or other wireless protocol.

In step 604, the ATM or POS may wirelessly detect one or more of the user's local wireless devices via Bluetooth, UWB, or other wireless protocol. And, in step 606, may wirelessly read, scan, or otherwise identify the unique hardware address(es) for the user's devices. An example type of address that could be identified is the MAC address for each device.

In step 608, the ATM or POS can transmit the account information, the security code, requested transaction type, requested transaction amount, and/or the MAC addresses to an authentication server for authentication and for computation of a trust score. Alternatively, such information may be used locally by the ATM or POS to perform the same functionality. One or more trust scores may be calculated based on the number of authenticated devices that are detected, historical information, validated biometric information, geographical location of the proposed transaction, etc. The number of authenticated devices (i.e., the number of preregistered devices that are confirmed to be locally present with the user at the proposed transaction site) can be compared with the known list of preregistered devices. For example, a user may have only one of their five devices with them, which might result in a lower trust score, or might have all five of five devices with them, which might warrant a higher trust score.

After calculation of a trust score and identification of corresponding transaction limits and/or rights like discussed above with respect to FIG. 4, an ATM or POS can receive a confirmation of the authentication and the transaction limited and/or type authorization based on the trust score in step 610. Again, limits, rights, and/or types of authorized or allowable transactions may be increased as the trust score increases or decreased as the trust score decreases.

In step 612, the ATM or POS can then process a transaction up to the transaction limit authorization corresponding to the trust score and/or allow certain transaction types based on the trust score. If the trust score is insufficient or other security criteria is not satisfied, the transaction may also be rejected.

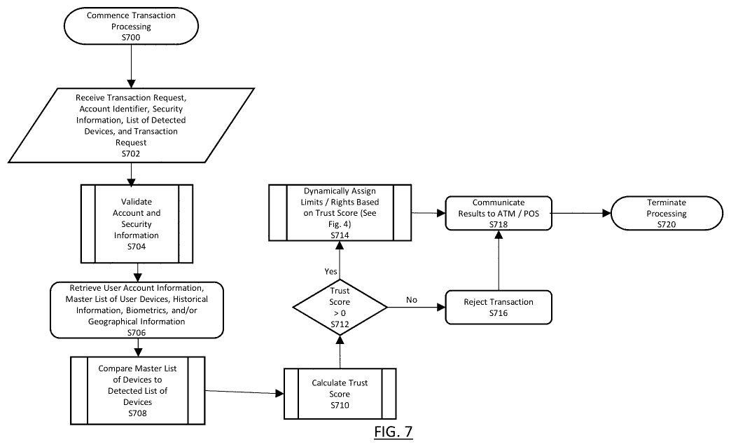

FIG. 7 is an illustrative flowchart of sample method steps, which focus on authentication server processing, that can be performed in accordance with various aspects of the disclosure to provide improved authentication of a user with a card based on Bluetooth, UWB, or other wireless detection of a user's local wireless devices with unique hardware addresses in which certain aspects of the present disclosure may be implemented.

In step 700, transaction processing may be commenced. This may result from an authentication server receiving a transaction request from an ATM or POS.

In step 702, the transaction request amount and type, the account identifier, security information, and/or list of detected devices present at the ATM or POS can be received or retrieved.

In steps 704 and 706, the user, account, and security information can be validated as successfully received. This may include account numbers, account types, user information, user preferences, user profiles, PINs, zip codes, security codes, and biometric information. And corresponding information may be retrieved from secure memory for comparison purposes to validate against the information received from the ATM or POS machines.

In particular, a known list of hardware addresses for the user's preregistered hardware devices may be retrieved from memory to compare against the devices locally detected (i.e., based on their local hardware addresses) in step 708. The more successfully detected devices that are detected the higher the trust score can be. Similarly, if different phones or devices are detected that are duplicative of the known devices, the potential for an unauthorized transaction may be present. For example, if a user has a particular iPhone that is preregistered and the detected iPhone at the ATM or POS is different, this may set a red flag for a potential problem. This problem would be increased as the number of non-matching devices are detected thereby reducing the trust score.

In step 710, a trust score can be calculated based on any number of desired variables. Again, this may be based on the number of detected preregistered devices, if there are duplicative non-registered devices detected, historical usage of the ATM or POS in the past, historical transaction types and amounts, the geographical location of the user and/or ATM or POS, etc. Any type of algorithm could be used. The primary thrust is that various of these factors increase the likelihood that the transaction is valid and the trust score would then be increased, and other factors would reduce the level of confidence in the requested transaction.

In step 712, if the trust score is zero, the transaction may be rejected for one or more reasons in step 716, and the rejection may be communicated to the ATM or POS in step 718, after which the process can be terminated.

Alternatively, if there is a positive trust score in step 712, the transaction limits and/or types can be dynamically set in accordance with predetermined levels in step 714 based on trust scores as shown in FIG. 4. The approval of transaction types, amounts, and/or rights can be communicated to the ATM or POS, after which the process can be terminated.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. An authentication process for a machine to authenticate a user with a card based on wireless detection of a user's local wireless devices comprising the steps of
a) reading, by the machine, account information corresponding to the card;
b) receiving, by the machine from the user, a security code for the card;
c) wirelessly detecting, by the machine, one or more of the user's local wireless devices;
d) receiving, by the machine from the one or more local wireless devices, one or unique hardware addresses for said one or more local wireless devices;
e) transmitting, by the machine, the account information, the security code, and the unique hardware addresses for authentication and a determination of a trust score;
f) receiving, by the machine, a confirmation of said authentication and a transaction limit authorization based on the trust score; and
g) processing, by the machine, a transaction up to the transaction limit authorization corresponding to the trust score.

2. The authentication process of claim 1 wherein the wireless detection uses a Bluetooth protocol or an Ultra-Wideband (UWB) protocol, and said one or more unique hardware addresses are media access control (MAC) addresses.

3. The authentication process of claim 1 wherein the machine is an automated teller machine (ATM) or a point-of-sale (POS) machine, and said one or more unique hardware addresses are media access control (MAC) addresses.

4. The authentication process of claim 1 wherein the wireless detection uses a Bluetooth protocol or an Ultra-Wideband (UWB) protocol, the machine is an automated teller machine (ATM) or a point-of-sale (POS) machine, and said one or more unique hardware addresses are media access control (MAC) addresses.

5. The authentication process of claim 4 wherein the trust score is calculated based on how many of said one or more MAC addresses are authenticated.

6. The authentication process of claim 5 wherein, as a number of the one or more MAC addresses are authenticated increases, the trust score increases.

7. The authentication process of claim 6 wherein the transaction limit authorization increases as the trust score increases.

8. The authentication process of claim 7 wherein the transaction limit authorization decreases as the trust score decreases.

9. The authentication process of claim 8 wherein the one or more local wireless devices are selected from the group consisting of: a smartphone, a smart watch, a tablet, a fitness tracker, a Tile tracker, wireless headphones, and an AirTag.

10. The authentication process of claim 9 wherein the transaction is declined if the trust score is below a minimum security threshold.

11. The authentication process of claim 10 wherein the trust score is further based on a historical number of said one or more local hardware devices that are present with the user at historical transactions at the machine.

12. The authentication process of claim 11 wherein the trust score is further based on historical usage by the user of a geographical location of the machine.

13. The authentication process of claim 12 further comprising the step of biometrically authenticating, by the machine or said one or more local wireless devices, the user.

14. The authentication process of claim 13 wherein the biometrical authentication is based on facial recognition, retinal scanning, fingerprint reading, or voice recognition.

15. The authentication process of claim 14 wherein the trust score is increased based on successful biometrical authentication of the user.

16. An automated teller system for use with an authentication server to authenticate a user with a card based on wireless detection of one or more of the user's local wireless devices, the system comprising:
a) at least one automated teller machine (ATM) having:
i) at least one processor;
ii) at least one non-wireless communication interface communicatively coupled to the at least one processor and the authentication server;
iii) a wireless card reader communicatively coupled to the at least one processor and the card;
iv) a wireless communication interface, communicatively coupled to the at least one processor, in wireless communication, via a Bluetooth protocol or Ultra-Wideband (UWB) protocol, with said one or more of the local wireless devices; and
v) a memory communicatively coupled to the at least one non-wireless communication interface, said memory storing ATM computer-executable instructions that, when executed by the at least one processor, cause the ATM to:
(1) wirelessly read, from the card, account information;
(2) wirelessly detect said one or more of the user's local wireless devices;
(3) wirelessly read one or more media access control (MAC) addresses for said one or more local wireless devices;
(4) transmit, to the authentication server, said account information and said one or more MAC addresses for authentication and for a determination of a trust score;
(5) receive, from the authentication server, said authentication and a transaction limit authorization based on the trust score;
(6) process a transaction if an amount of the transaction is less than or equal to the transaction limit authorization; and
(7) reject the transaction if the amount of the ATM transaction is greater than the transaction limit authorization,
wherein the trust score is calculated based on how many of said one or more MAC addresses are authenticated, the trust score increases as a quantity of the one or more MAC addresses are authenticated increases, the transaction limit authorization increases as the trust score increases, the trust score decreases as the quantity of the one or more MAC addresses authenticated decreases, and the transaction limit authorization decreases as the trust score decreases.

17. The system of claim 16 wherein the trust score is further based on a historical number of said one or more local wireless devices that are present with the user at historical transactions at the ATM.

18. The system of claim 17 wherein the one or more local wireless devices are selected from the group consisting of: a smartphone, a smart watch, a tablet, a fitness tracker, a Tile tracker, wireless headphones, and an AirTag.

19. The system of claim 18 wherein the transaction is executed in a contactless fashion without physical contact between the user and the ATM.

20. A contactless automated teller system to authenticate a user with a card based on wireless detection of one or more of the user's local wireless devices, the system comprising:
a) an automated teller machine (ATM) having:
i) an ATM processor;
ii) an ATM communication interface communicatively coupled to the ATM processor;
iii) an ATM wireless interface, communicatively coupled to the ATM processor, in wireless communication, via a Bluetooth protocol or Ultra-Wideband (UWB) protocol, with said one or more of the local wireless devices and with the card;
b) an authentication server having:
i) an authentication processor;
ii) an authentication communication interface communicatively coupled to the authentication processor and the ATM communication interface; and
c) an ATM memory communicatively coupled to the ATM communication interface and an authentication memory communicatively coupled to the authentication communication interface, said ATM memory storing ATM computer-executable instructions that, when executed by the ATM processor, cause the ATM to perform ATM functions, and said authentication memory communicatively coupled to the authentication communication interface, said authorization memory storing authentication computer-executable instructions that, when executed by the authentication processor cause the authentication server to perform server functions, in which:
i) the ATM wirelessly reads, via the wireless interface, card information for the card;
ii) the ATM wirelessly reads, via the wireless interface, one or more media access control (MAC) addresses for said one or more local wireless devices;
iii) the ATM transmits, from the ATM communication interface to the authentication communication interface, said card information and said one or more MAC addresses;
iv) the authentication processor receives, from the authentication communication interface, said card information and said one or more MAC addresses;
v) the authentication processor retrieves, from the authentication memory, account information corresponding to the card information and a known list of the user's local wireless devices;
vi) the authentication processor calculates a trust score based on:
(1) the account information, and
(2) a ratio of said one or more MAC addresses that were detected to the known list of the user's local wireless devices, where in the trust score varies directly with the ratio;
vii) the authentication processor sets a transaction limit based on the trust score and the account information;
viii) the authentication processor transmits, from the authentication communication interface to the ATM communication interface, the transaction limit;
ix) the ATM processor receives, from the ATM communication interface, the transaction limit;
x) the ATM processor processes a transaction if an amount of the transaction is less than or equal to the transaction limit authorization; and
xi) the ATM processor rejects the transaction if the amount of the ATM transaction is greater than the transaction limit authorization.
